(19) United States
(12) Patent Application Publication
(10) Pub. No.: US 2003/0007569 A1
(43) Pub. Date: Jan. 9, 2003

(54) Wideband modulation

(76) Inventor: Gaetano Roberto Aiello, Palo Alto, CA (US)

Correspondence Address: RITTER VAN PELT & YI, L.L.P., 4906 EL CAMINO REAL, SUITE 205, LOS ALTOS, CA, 94022

(21) Appl. No.: 10/165,604

(22) Filed: Jun. 7, 2002

Related U.S. Application Data
(60) Provisional application No. 60/296,954, filed on Jun. 8, 2001.
(60) Provisional application No. 60/310,959, filed on Aug. 7, 2001.

(51) Int. Cl. H04L 27/20; H04L 27/12; H04L 27/04

(52) U.S. Cl. 375/295

(57) ABSTRACT

Generating a wideband modulated signal includes modulating a substantially continuous waveform according to a modulation scheme and chopping the modulated substantially continuous waveform to generate a chopped signal having a broader spectrum than the spectrum of the substantially continuous waveform. The modulation of the substantially continuous waveform is detectable from the chopped waveform.

### CROSS REFERENCE TO RELATED APPLICATIONS

This application claims priority to U.S. Provisional Patent Application No. 60/296,954 (Attorney Docket No. AIELP001+) entitled “Method to Improve Performance of Radio Systems By Maintaining Interoperability” filed Jun. 8, 2001, which is incorporated herein by reference for all purposes, and U.S. Provisional Patent Application No. 60/310,959 (Attorney Docket No. AIELP002+) which is incorporated herein by reference for all purposes.

### FIELD OF THE INVENTION

The present invention relates generally to communication systems. More specifically, wideband modulation is disclosed.

### BACKGROUND OF THE INVENTION

Continuous wave communication systems such as Bluetooth use various modulation techniques including phase shift keying, frequency modulation, and amplitude modulation. It would be useful if better modulation techniques could be developed for wideband or ultrawideband systems that transmit and receive pulses. In particular, it would be useful if pulsed modulation techniques could be used in a manner that is compatible with existing continuous wave systems.

### DETAILED DESCRIPTION

It should be appreciated that the present invention can be implemented in numerous ways, including as a process, an apparatus, a system, or a computer readable medium such as a computer readable storage medium or a computer network wherein program instructions are sent over optical or electronic communication links. It should be noted that the order of the steps of disclosed processes may be altered within the scope of the invention.

A detailed description of one or more preferred embodiments of the invention are provided below along with accompanying figures that illustrate by way of example the principles of the invention. While the invention is described in connection with such embodiments, it should be understood that the invention is not limited to any embodiment. On the contrary, the scope of the invention is limited only by the appended claims and the invention encompasses numerous alternatives, modifications and equivalents. For the purpose of example, numerous specific details are set forth in the following description in order to provide a thorough understanding of the present invention. The present invention may be practiced according to the claims without some or all of these specific details. For the purpose of clarity, technical material that is known in the technical fields related to the invention has not been described in detail so that the present invention is not unnecessarily obscured.

The Bandwidth (TBW) extends existing Bluetooth 1.1 (BT) with wideband signaling. A TBW-enabled BT system provides higher bit rate and better interference rejection. A TBW enabled BT radio is interoperable with BT and uses much of the same circuitry. It is also possible to design TBW technology in other standards such as GSM, 3G, IEEE 802.11 to improve their performance and maintain interoperability. In addition, TBW may also be applied by itself, without combination with a continuous wave modulation scheme.

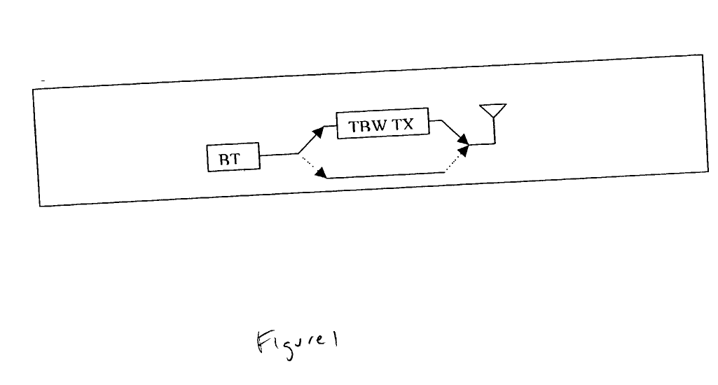

TBW spreads the transmitted signal across the spectrum by operating on the standard transmitter, as shown in FIG. 1. The transmitter can be switched between normal operation and TW-enabled operation. The carrier frequency f_{c} gated for a time interval τ causes a spectrum spread equal to:

BW_{3 dB}=0.88/τ (0.1)

and

BW_{10 dB}=1.48/τ. (0.2)

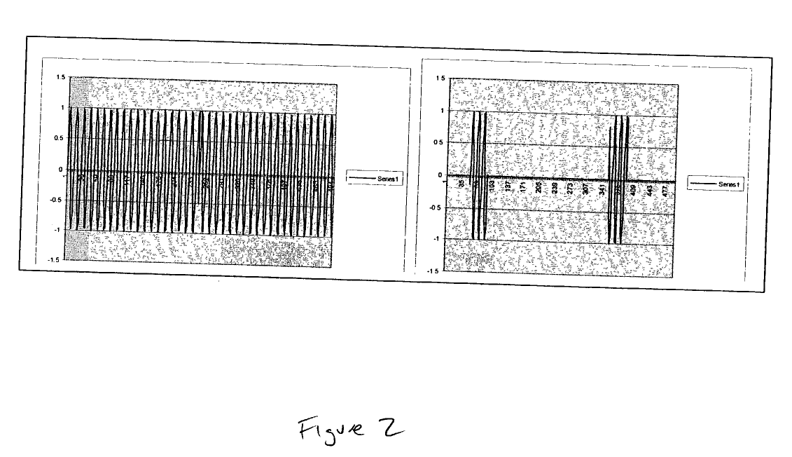

For example for f_{c}=2.4 GHz and τ=12 ns, BW_{3B}=73 MHz and BW_{10 dB}=123 MHz. An example of TBW enabled transmitter is shown in FIG. 2, where a BPSK signal is gated for three cycles.

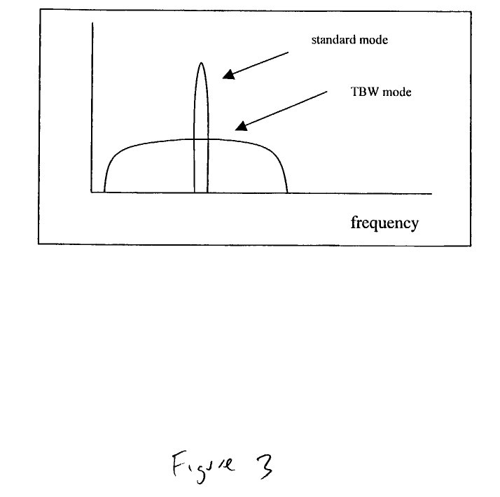

The spectrum is spread according to the relationship described above, as shown in FIG. 3. In this case, for fc=2.6 GHz, for example, the spectrum is spread to 760 MHz at the −3 dB point. The instantaneous power during the gate-on time is the same but both the total power and the power spectral density is much lower, only 0.1%/MHz in this case.

When the receiver is in standard mode, it behaves like a standard receiver. When it is in TBW mode, it detects the gated signal. The receiver can be switched between standard and TBW-enabled mode. The system is maintained interoperable with the standard mode by maintaining the standard signaling except for the payload, where different modulation is employed.

The signal in TBW mode has larger bandwidth. The receiver is desensitized, proportionally to the bandwidth, because the thermal noise power increases linearly with the bandwidth. However, the following advantages can be exploited:

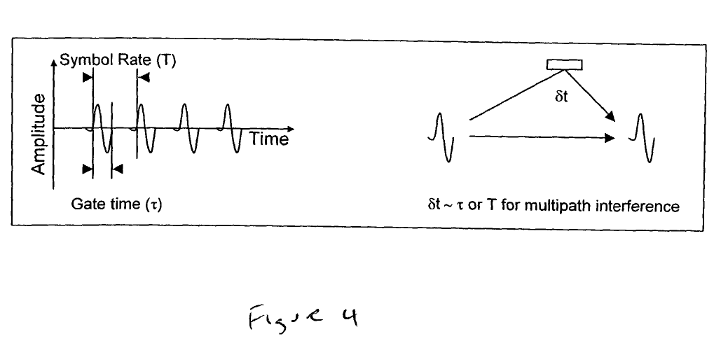

1. Multipath fading. The signal is not affected by fading as much as a narrowband signal, because there is less likelihood of destructive interference at the receiver, as shown in FIG. 4.

2. Frequency diversity. The larger bandwidth also allows frequency selectivity. The maximum theoretical number of resolvable paths is

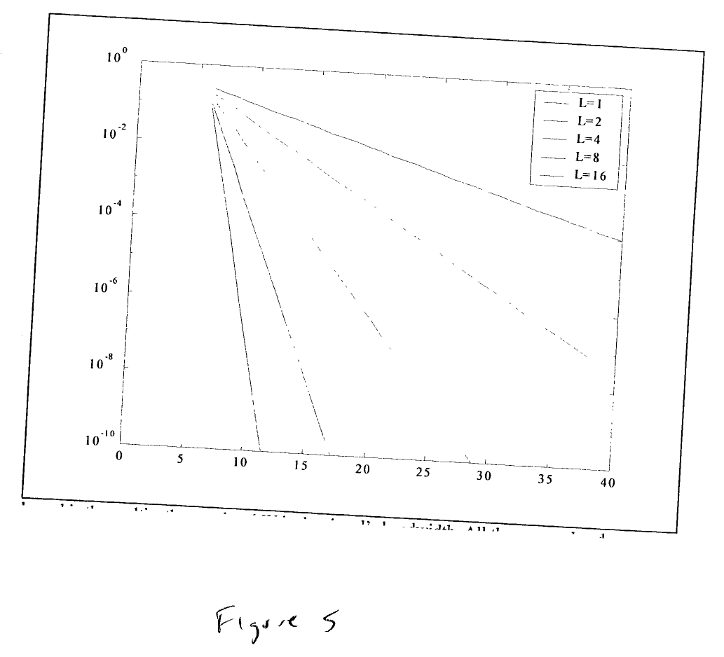

paths=d*W, (0.3)

where d is the multipath spread and W is the signal's bandwidth. All the uncorrelated paths can be combined in a rake receiver, resulting in a tremendous improvement in performance as compared to a narrowband rake, as shown in FIG. 5, where the bit error rate (BER) is shown as a function of SNR for different number of rakes. This particular picture shows square-law combining. The improvement for BER=10⁻⁴ from one to two path is 17 dB, in this example.

3. Capacity. The communication system's capacity is defined by Shannon formula:

C=W*log₂(1+S/N) (0.4)

It shows that the capacity is linearly proportional to the bandwidth and logarithmically proportional to SNR. If, for example the bandwidth of a system is increased from 1 MHz to 100 MHz, its SNR decreases by a factor of 100, but its capacity increases by 40%. It is sometimes possible to increase this value even more if radio regulations allow to increase the signal power spectral density, reducing the SNR loss.

In one embodiment, TBW is applied to a Bluetooth system. The bit rate of a BT 1.1 radio is increased to 16 Mb/s with interoperability maintained. BT radio's signaling is FSK at 1 MHz symbol rate. This design adds 8-PPM, changing the signaling from 1 bit/symbol to 4 bits/symbol, and the symbol rate is increased to 4 MHz.

Each FSK symbol is divided in 8 time slots, each of them 15.625 ns long for a total of 125 ns. The timing is derived from the 32 MHz clock. The signal's duration in the slot is 12 ns, that is equivalent to the full 73 MHz bandwidth. The bit rate can be additionally increased to 20 Mb/s or 24 Mb/s by adding PSK modulation (either BPSK or QPSK) to the previous scheme.

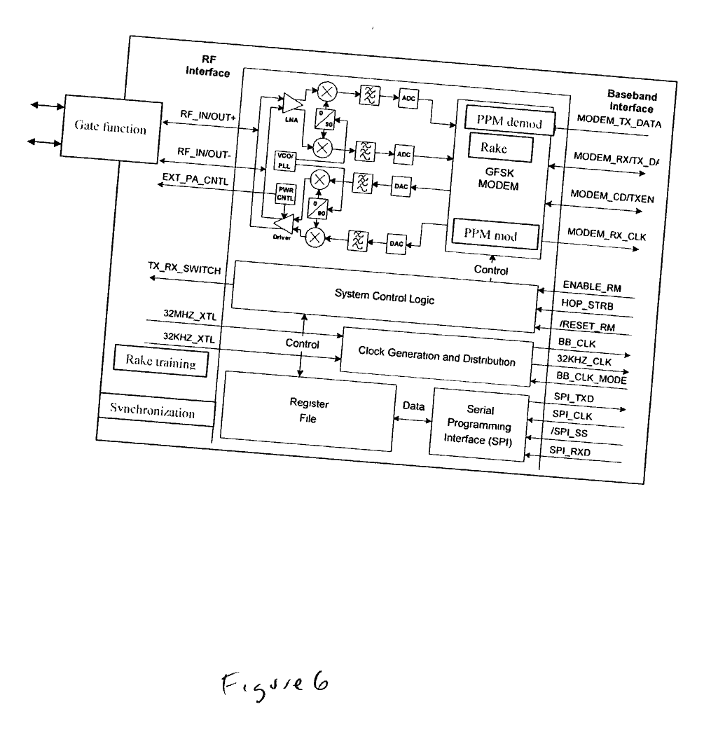

FIG. 6 shows a typical Bluetooth block diagram with the following blocks added:

Transmitter

A gate function turns the transmitted signal on for 12 ns at the right time slot. A pulse position modulator encodes the bit stream in symbols. It generates the timing information related to the time slot and it passes it to the gate function.

Receiver

A pulse position demodulator detects the position of the symbol in the slots by sampling all 8 slots. A synchronization block provides fine synchronization by reducing the 50 ns jitter of BT radio down to 0.5 ns. Up to four rakes are used to take advantage of the 80 MHz bandwidth. They are realized with additional ADCs, the outputs combined in baseband. Rake training is used to provide correct timing information to the rake.

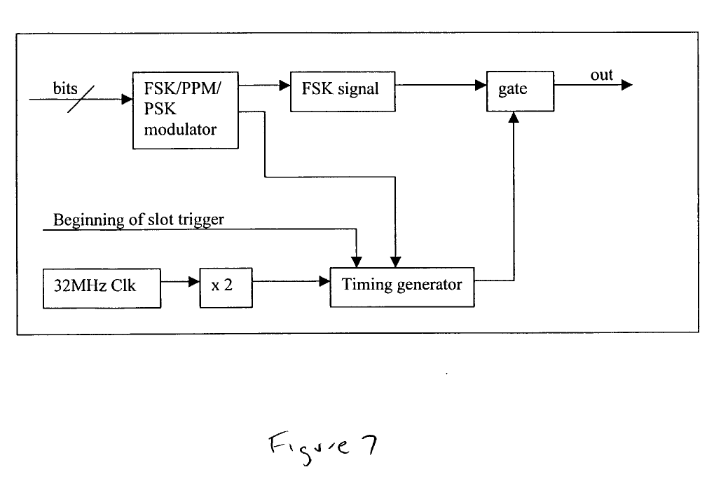

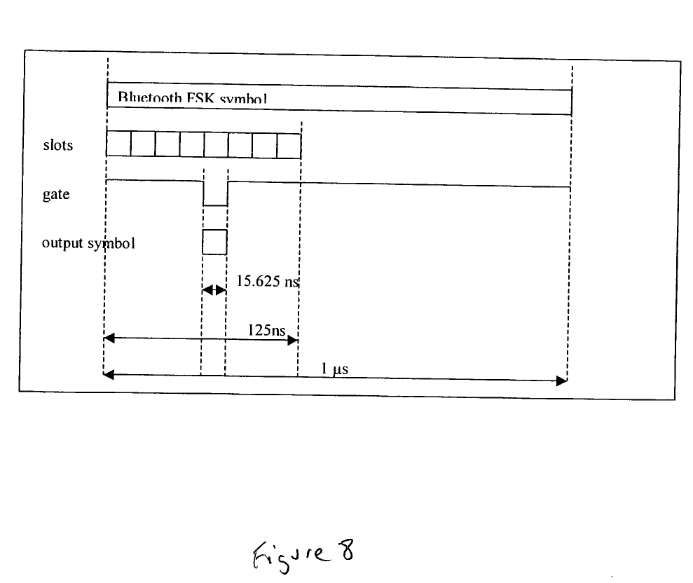

In the transmitter, the FSK modulated signal is fed into the gate function and gated to the right time slot, as shown in FIG. 7. The timing is shown in FIG. 8.

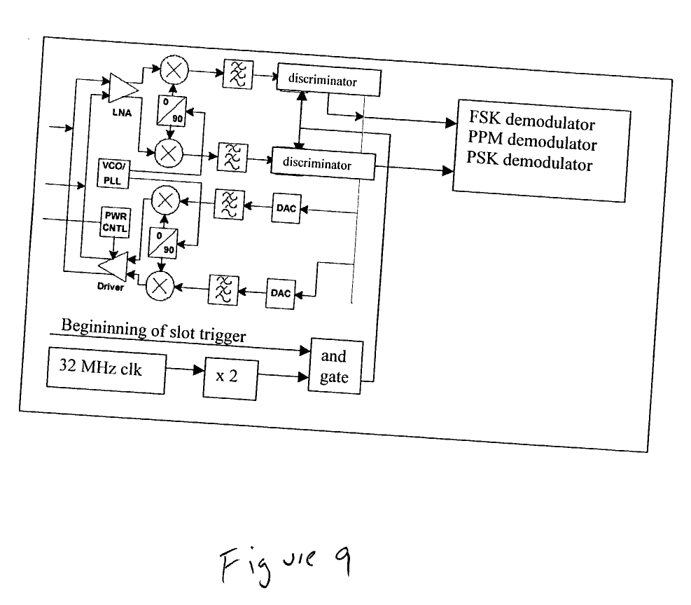

In the receiver, the FSK signal is demodulated at the right time slot, according to FIG. 8. The receiver's block diagram in shown in FIG. 9. Each slot is digitized and FSK demodulated. The pulse position is detected by comparing the FSK signal with the slot's timing information.

The objective of the rake is to increase the available SNR but detecting independent paths. A different set of ADCs is used for each finger of the rake. Each finger has also separate timing information to synchronize to the correct timing. If the sampling rate of the ADCs shown in FIG. 9 is high enough, the same circuit can be used for the rake receiver.

Since the clock accuracy specified by BT is 20 ppm and the maximum number of symbols is 2745, the maximum error provided by the clock is 55 ns. This accuracy is not sufficient to assure detection of all symbols in PPM mode. For this reason a special synchronization circuit must be added to improve this accuracy.

Although the foregoing invention has been described in some detail for purposes of clarity of understanding, it will be apparent that certain changes and modifications may be practiced within the scope of the appended claims. It should be noted that there are many alternative ways of implementing both the process and apparatus of the present invention. Accordingly, the present embodiments are to be considered as illustrative and not restrictive, and the invention is not to be limited to the details given herein, but may be modified within the scope and equivalents of the appended claims.

What is claimed is:

1. A method of generating a wideband modulated signal including:
modulating a substantially continuous waveform according to a modulation scheme;
chopping the modulated substantially continuous waveform to generate a chopped signal having a broader spectrum than the spectrum of the substantially continuous waveform;
wherein the modulation of the substantially continuous waveform is detectable from the chopped waveform.
